(19) United States
(12) Patent Application Publication
(10) Pub. No.: US 2025/0069183 A1
(43) Pub. Date: Feb. 27, 2025

(54) METHOD AND APPARATUS OF PROCESSING IMAGE, INTERACTIVE DEVICE, ELECTRONIC DEVICE, AND STORAGE MEDIUM

(71) Applicant: BOE TECHNOLOGY GROUP CO., LTD., Beijing (CN)

(72) Inventors: Siyan Ma, Beijing (CN); Hao Zhang, Beijing (CN); Xinkai Li, Beijing (CN); Yaoyu Lv, Beijing (CN); Yan Li, Beijing (CN)

(21) Appl. No.: 18/553,155

(22) PCT Filed: Dec. 1, 2022
(86) PCT No.: PCT/CN2022/135733

§ 371 Date: Sep. 28, 2023

(51) Int. Cl. G06T 3/14; G06T 5/80; G06V 40/16

(52) U.S. Cl. CPC G06T 3/14; G06T 5/80; G06V 40/166

(57) ABSTRACT

The present disclosure provides a method and an apparatus of processing an image, an interactive device, an electronic device, a storage medium, and a computer program product, which relate to a field of image processing technology. The method of processing the image includes: constructing an initial three-dimensional face template by using a plurality of sample face images; performing an iterative optimization on the initial three-dimensional face template by using a face image of a target object, so as to obtain a target three-dimensional face template; and determining a current face pose of the target object according to a corresponding relationship between a current face image of the target object and the target three-dimensional face template.

### CROSS-REFERENCE TO RELATED APPLICATION

This application is a Section 371 National Stage Application of International Application No. PCT/CN2022/135733, filed on Dec. 1, 2022, entitled “METHOD AND APPARATUS OF PROCESSING IMAGE, INTERACTIVE DEVICE, ELECTRONIC DEVICE, AND STORAGE MEDIUM”, the content of which is hereby incorporated by reference in its entirety.

### TECHNICAL FIELD

The present disclosure relates to a field of image processing technology, in particular to a method and an apparatus of processing an image, an interactive device, an electronic device, a storage medium, and a computer program product.

### BACKGROUND

Augmented Reality (AR) devices, Virtual Reality (VR) devices and three-dimensional (3D) screen interactive devices generally need to acquire a relative face pose of a user in real time and adjust a display effect according to the relative face pose, so as to provide the user with a more realistic experience. For example, a glasses-free 3D screen may adjust opening and closing of an internal grating of the screen according to a real-time pose of face, head or pupils of the user, so that an optimal glasses-free 3D viewing effect may be presented to the user in a current viewing pose.

At present, a traditional pose estimation algorithm is implemented to perform a pose estimation based on a rigid object and a fixed template. However, a face image is a typical non-rigid object, and each face image has individual differences. AR devices, VR devices or 3D screen interactive devices are applicable to a wide range of users, and it is difficult to obtain accurate face pose estimation results for different users by using the traditional pose estimation algorithms.

### SUMMARY

The present disclosure provides a method and an apparatus of processing an image, an interactive device, an electronic device, a storage medium, and a computer program product.

According to a first aspect, the present disclosure provides a method of processing an image, including: constructing an initial three-dimensional face template by using a plurality of sample face images; performing an iterative optimization on the initial three-dimensional face template by using a face image of a target object, so as to obtain a target three-dimensional face template; and determining a current face pose of the target object according to a corresponding relationship between a current face image of the target object and the target three-dimensional face template.

For example, the constructing an initial three-dimensional face template by using a plurality of sample face images includes: acquiring a plurality of three-dimensional sample key points from each of the plurality of sample face images; determining an average three-dimensional face template according to a plurality of three-dimensional sample key points of the plurality of sample face images; determining a feature matrix of the plurality of sample face images by using the average three-dimensional face template; and constructing the initial three-dimensional face template according to an iteration parameter, the average three-dimensional face template and the feature matrix.

For example, the determining a feature matrix of the plurality of sample face images by using the average three-dimensional face template includes: performing a decentralization on the plurality of three-dimensional sample key points of the plurality of sample face images by using the average three-dimensional face template, so as to obtain a covariance matrix; calculating a plurality of feature values of the covariance matrix and a plurality of feature vectors corresponding to the plurality of feature values; determining a plurality of valid feature vectors from the plurality of feature vectors according to contribution values of the plurality of feature values to a linear projection in the covariance matrix, where a sum of the contribution values of a plurality of feature values corresponding to the plurality of valid feature vectors is greater than a predetermined contribution value; and constructing the feature matrix according to the plurality of valid feature vectors.

For example, the performing an iterative optimization on the initial three-dimensional face template by using a face image of a target object so as to obtain a target three-dimensional face template includes: acquiring a plurality of two-dimensional target key points from the face image of the target object; determining a plurality of three-dimensional key points from the initial three-dimensional face template; projecting the plurality of three-dimensional key points into a plurality of two-dimensional projection key points; calculating an average error between the plurality of two-dimensional projection key points and the plurality of two-dimensional target key points; and performing the iterative optimization on the initial three-dimensional face template according to the average error, so as to obtain the target three-dimensional face template.

For example, the projecting the plurality of three-dimensional key points into a plurality of two-dimensional projection key points includes: constructing a weak perspective projection model according to coordinate values of the three-dimensional key points, a scaling ratio, a coordinate system rotation matrix, and a center point offset vector of a pixel coordinate system; and projecting the plurality of three-dimensional key points into a plurality of two-dimensional projection key points by using the weak perspective projection model.

For example, the weak perspective projection model is configured to project the plurality of three-dimensional key points into a plurality of two-dimensional projection key points according to:

$$[ \begin{matrix}x \\ y\end{matrix} ] = scale \cdot [ \begin{matrix}{R}_{00} & {R}_{01} & {R}_{02} \\ {R}_{10} & {R}_{11} & {R}_{21}\end{matrix} ] \cdot [ \begin{matrix}X \\ Y \\ Z\end{matrix} ] + [ \begin{matrix}{t}_{x} \\ {t}_{y}\end{matrix} ]$$

where x and y respectively represent coordinate values of the two-dimensional projection key points on x-axis and y-axis of the pixel coordinate system, X, Y and Z respectively represent coordinate values of the three-dimensional key points on x-axis, y-axis and z-axis of a coordinate system where the target object is located, scale represents the scaling ratio,

$$[ \begin{matrix}{R}_{00} & {R}_{01} & {R}_{02} \\ {R}_{10} & {R}_{11} & {R}_{21}\end{matrix} ]$$

represents a rotation matrix of the coordinate system where the target object is located with respect to a camera coordinate system, and tₓ and t_{y} respectively represent offset vectors of an origin of the pixel coordinate system with respect to an origin of the camera coordinate system on x-axis and y-axis.

For example, the performing the iterative optimization on the initial three-dimensional face template according to the average error so as to obtain the target three-dimensional face template includes: constructing an iteration model according to the weak perspective projection model and the iteration parameter; determining a mapping function between the iteration model and the plurality of two-dimensional projection key points; calculating a Jacobi matrix of the mapping function to obtain iteratively-optimized two-dimensional iterative key points; calculating an average error according to the two-dimensional iterative key points and the plurality of two-dimensional target key points from the face image; updating a parameter of the iteration model in a descent gradient direction of the Jacobi matrix to obtain an updated iteration model, and returning to an operation of determining the mapping function between the iteration model and the plurality of two-dimensional projection key points, in response to a determination that the average error does not meet a convergence condition; and determining the iteration parameter and constructing the target three-dimensional face template according to the iteration parameter, in response to a determination that the average error meets the convergence condition.

For example, the mapping function includes:

$$F ( [ \begin{matrix}scale \\ {R}_{x} \\ {R}_{y} \\ {R}_{z} \\ {t}_{x} \\ {t}_{y} \\ params\end{matrix} ] ) = [ \begin{matrix}current\_shape \_ 2 D\_x \\ current\_shape \_ 2 D\_y\end{matrix} ]$$

$$where [ \begin{matrix}current\_shape \_ 2 D\_x \\ current\_shape \_ 2 D\_y\end{matrix} ]$$

represents a coordinate value matrix of the plurality of two-dimensional projection key points,

$$F ( [ \begin{matrix}scale \\ {R}_{x} \\ {R}_{y} \\ {R}_{z} \\ {t}_{x} \\ {t}_{y} \\ params\end{matrix} ] )$$

represents the iteration model, scale represents the scaling ratio, Rₓ, R_{y} and R_{z} represent rotation amounts of the coordinate system where the target object is located with respect to the camera coordinate system, tₓ and t_{y} respectively represent offset vectors of an origin of the pixel coordinate system with respect to an origin of the camera coordinate system on x-axis and y-axis, and params represents the iteration parameter.

For example, the updating a parameter of the iteration model in a descent gradient direction of the Jacobi matrix to obtain an updated iteration model includes: calculating a parameter variation of the iteration model according to the descent gradient direction of the Jacobi matrix and the average error; and updating the parameter of the iteration model according to the parameter variation, so as to obtain the updated iteration model.

For example, the updating the parameter of the iteration model according to the parameter variation so as to obtain the updated iteration model includes updating the iteration model according to:

$$[ \begin{matrix}{scale}^{′} \\ {R}_{x}^{′} \\ {R}_{y}^{′} \\ {R}_{z}^{′} \\ {t}_{x}^{′} \\ {t}_{y}^{′} \\ {params}^{′}\end{matrix} ] = [ \begin{matrix}scale \\ {R}_{x} \\ {R}_{y} \\ {R}_{z} \\ {t}_{x} \\ {t}_{y} \\ params\end{matrix} ] - delta$$

$$where [ \begin{matrix}{scale}^{′} \\ {R}_{x}^{′} \\ {R}_{y}^{′} \\ {R}_{z}^{′} \\ {t}_{x}^{′} \\ {t}_{y}^{′} \\ {params}^{′}\end{matrix} ]$$

represents the updated iteration model,

$$[ \begin{matrix}scale \\ {R}_{x} \\ {R}_{y} \\ {R}_{z} \\ {t}_{x} \\ {t}_{y} \\ params\end{matrix} ]$$

represents an un-updated iteration model, and delta represents the parameter variation.

For example, the calculating an average error between the plurality of two-dimensional projection key points and the plurality of two-dimensional target key points includes: calculating a re-projection error according to the plurality of two-dimensional projection key points and the plurality of two-dimensional target key points; and calculating the average error according to the re-projection error.

For example, the calculating the average error according to the re-projection error includes calculating the average error according to:

$$error = \frac{1}{68} {\sum }_{i = 0}^{67} {‖ {proj}_{err} ‖}^{2}$$

where error represents the average error, projₑᵣᵣ represents the re-projection error, projₑᵣᵣ=landmarks_2D-current_shape_2D, landmarks_2D represents the coordinate values of the two-dimensional target key points, and current_shape_2D represents the coordinate values of the two-dimensional projection key points.

For example, the determining a current face pose of the target object according to a corresponding relationship between a current face image of the target object and the target three-dimensional face template includes: determining a plurality of predetermined three-dimensional key points of the target object from a plurality of three-dimensional key points of the target three-dimensional face template, where the plurality of predetermined three-dimensional key points are located in a target coordinate system, and the plurality of predetermined three-dimensional key points correspond to a plurality of specified two-dimensional key points of the current face image of the target object; determining a transformation matrix between the camera coordinate system and the target coordinate system according to a corresponding relationship between the pixel coordinate system where the face image from a camera is located and the target coordinate system; converting the plurality of predetermined three-dimensional key points into a plurality of target three-dimensional key points according to the transformation matrix, where the plurality of target three-dimensional key points are located in the camera coordinate system; and determining the current face pose of the target object according to the plurality of target three-dimensional key points.

For example, the determining a transformation matrix between the camera coordinate system and the target coordinate system according to a corresponding relationship between the pixel coordinate system where the face image from a camera is located and the target coordinate system includes determining the transformation matrix according to:

$$c [ \begin{matrix}x \\ y \\ 1\end{matrix} ] = K \cdot [ \begin{matrix}R & t \\ 0 & 1\end{matrix} ] \cdot [ \begin{matrix}X \\ Y \\ Z \\ 1\end{matrix} ]$$

where c represents a scale of the camera, x and y respectively represent coordinate values of the two-dimensional projection key points on x-axis and y-axis of the pixel coordinate system, X, Y and Z respectively represent coordinate values of the predetermined three-dimensional key points on x-axis, y-axis and z-axis of the target coordinate system, K represents an internal parameter matrix of the camera, and

$$[ \begin{matrix}R & t \\ 0 & 1\end{matrix} ]$$

represents the transformation matrix.

For example, the acquiring a plurality of two-dimensional target key points from the face image of the target object includes: performing a distortion correction on the face image to obtain a corrected face image; and determining the plurality of two-dimensional target key points from the corrected face image by using a key point detection algorithm.

For example, the performing a distortion correction on the face image to obtain a corrected face image includes performing the distortion correction on the face image according to:

$$\{ \begin{matrix}{x}_{0} = x ( 1 + {k}_{1} {r}^{2} + {k}_{2} {r}^{4} + {k}_{3} {r}^{6} ) \\ {y}_{0} = y ( 1 + {k}_{1} {r}^{2} + {k}_{2} {r}^{4} + {k}_{3} {r}^{6} ) \\ {x}_{0} = x + [ 2 {p}_{1} x y + {p}_{2} ( {r}^{2} + 2 {x}^{2} ) ] \\ {x}_{0} = x + [ 2 {p}_{1} x y + {p}_{2} ( {r}^{2} + 2 {x}^{2} ) ]\end{matrix}$$

where x₀ and y₀ respectively represent coordinate values of a coordinate point on the face image on x-axis and y-axis, x and y respectively represent coordinate values of a coordinate point on the corrected face image on x-axis and y-axis, r represents a distance between a center point of the face image and the coordinate point (x, y), k₁, k₂ and k₃ are radial distortion coefficients, and p₁ and p₂ are tangential distortion coefficients.

According to a second aspect, the present disclosure provides an apparatus of processing an image, including: a construction module configured to construct an initial three-dimensional face template by using a plurality of sample face images; an iteration module configured to perform an iterative optimization on the initial three-dimensional face template by using a face image of a target object, so as to obtain a target three-dimensional face template; and a determination module configured to determine a current face pose of the target object according to a corresponding relationship between a current face image of the target object and the target three-dimensional face template.

According to a third aspect, the present disclosure provides an interactive device, including: a camera configured to acquire a face image of a target object; a processor electrically connected to the camera, where the processor is configured to: perform an iterative optimization on an initial three-dimensional face template by using the face image so as to obtain a target three-dimensional face template; perform a face pose estimation by using the target three-dimensional face template so as to obtain pupil coordinates of the target object; and calculate a grating opening and closing sequence according to the pupil coordinates; a driving circuit electrically connected to the processor, where the driving circuit is configured to control an output interface to output the grating opening and closing sequence; and a screen electrically connected to the driving circuit, where the screen is configured to control opening and closing of a grating in the screen according to the grating opening and closing sequence.

According to a fourth aspect, the present disclosure provides an electronic device, including: one or more processors; and a memory configured to store one or more programs, where the one or more programs, when executed by the one or more processors, are configured to cause the one or more processors to implement the method described in the embodiments of the present disclosure.

According to a fifth aspect, the present disclosure provides a computer-readable storage medium having executable instructions therein, and the instructions, when executed by a processor, are configured to cause the processor to implement the method described in the embodiments of the present disclosure.

According to a sixth aspect, the present disclosure provides a computer program product containing a computer program, and the computer program, when executed by a processor, is configured to implement the method described in the embodiments of the present disclosure.

### BRIEF DESCRIPTION OF THE DRAWINGS

FIG. 1 shows a flowchart of a method of processing an image according to the embodiments of the present disclosure;

FIG. 2A shows an application scenario diagram of the method of processing the image according to the embodiments of the present disclosure;

FIG. 2B shows a flowchart diagram of the method of processing the image according to the embodiments of the present disclosure;

FIG. 2C shows a schematic diagram of a distribution of key points in a face image according to the embodiments of the present disclosure;

FIG. 3 shows a flowchart of constructing an initial three-dimensional face template according to the embodiments of the present disclosure;

FIG. 4 shows a flowchart of iterating the initial three-dimensional face template according to the embodiments of the present disclosure;

FIG. 5 shows a flowchart of iterating the initial three-dimensional face template according to other embodiments of the present disclosure;

FIG. 6A shows a flowchart of determining a face pose of a target object according to the embodiments of the present disclosure;

FIG. 6B shows a schematic diagram of a transformation from a target coordinate system to a camera coordinate system according to the embodiments of the present disclosure;

FIG. 7 shows a structural block diagram of an apparatus of processing an image according to the embodiments of the present disclosure; and

FIG. 8 shows a block diagram of an electronic device suitable for implementing a method of processing an image according to the embodiments of the present disclosure.

### DETAILED DESCRIPTION OF EMBODIMENTS

In order to make objectives, technical solutions and advantages of the present disclosure clearer, the technical solutions in the embodiments of present disclosure are clearly and completely described below with reference to the drawings in the embodiments of the present disclosure. Obviously, the described embodiments are only a part but not all of the embodiments of the present disclosure. Based on the described embodiments of the present disclosure, all additional embodiments obtained by those ordinary skilled in the art without carrying out inventive effort fall within the protection scope of the present disclosure. It should be noted that throughout the drawings, the same elements are represented by the same or similar reference numerals. In the following descriptions, some specific embodiments are only used for descriptive purposes and should not be construed as limiting the present disclosure, but rather examples of the embodiments of the present disclosure. When it is possible to cause confusions in the understanding of the present disclosure, conventional structures or configurations will be omitted. It should be noted that the shape and size of each component in the figures do not reflect the actual size and ratio, but just illustrate the contents of the embodiments of the present disclosure.

Unless otherwise defined, the technical or scientific terms used in the embodiments of the present disclosure should have the usual meanings understood by those skilled in the art. The words “first,” “second,” and the like used in the embodiments of the present disclosure do not indicate any order, quantity or importance, but are just used to distinguish different composition parts.

In technical solutions of the present disclosure, a collection, a storage, a use, a processing, a transmission, a provision, a disclosure, an application and other processing of user personal information involved comply with provisions of relevant laws and regulations, take necessary security measures, and do not violate public order and good custom.

In the technical solutions of the present disclosure, the acquisition or collection of user personal information has been authorized or allowed by users.

Various embodiments according to the present disclosure will be described in detail below with reference to the accompanying drawings. It should be noted that in the accompanying drawings, the same reference numerals are assigned to composition parts that have substantially the same or similar structures and functions, and repeated descriptions about them will be omitted.

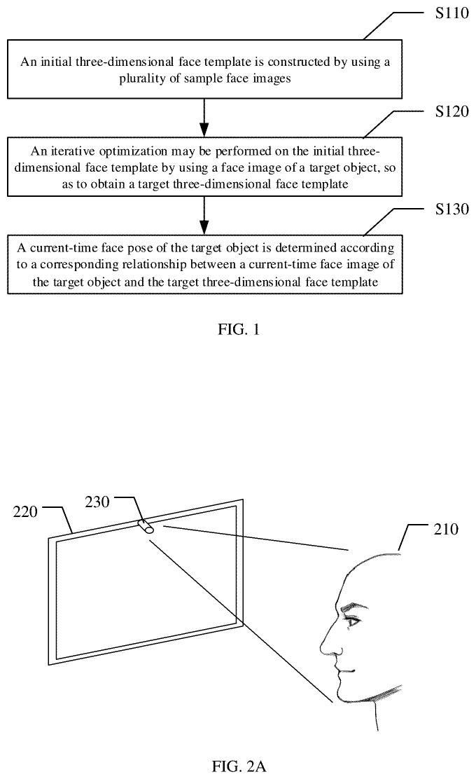

FIG. 1 shows a flowchart of a method of processing an image according to the embodiments of the present disclosure.

As shown in FIG. 1, the method of processing the image according to the embodiments of the present disclosure may include step S110 to step S130 as follows. It should be noted that the sequence number of each step in the following method is just used to indicate the step for ease of description, and should not be regarded as indicating the execution order of the steps. Unless explicitly stated, the method does not need to be performed exactly in the order shown.

In step S110, an initial three-dimensional face template is constructed by using a plurality of sample face images.

For example, the plurality of sample face images may be pre-collected face images of a plurality of users. For example, the plurality of sample face images may be sourced from an open-source Large Scale 3D Faces in-the-Wild (LS3D-W) dataset. The plurality of sample face images may include two-dimensional face images and three-dimensional face images. Two-dimensional coordinate points and three-dimensional coordinate points on the sample face images may be acquired from the plurality of sample face images.

In the embodiments of the present disclosure, the initial three-dimensional face template may be constructed according to a plurality of two-dimensional coordinate points and three-dimensional coordinate points from a plurality of sample face data. The initial three-dimensional face template may be a general three-dimensional face template used to indicate an average feature of face images.

In step S120, an iterative optimization may be performed on the initial three-dimensional face template by using a face image of a target object, so as to obtain a target three-dimensional face template.

For example, the target object may be a user using a head-mounted display device (such as AR or VR) or 3D screen interactive device. A camera is installed on the head-mounted display device or 3D screen interactive device. When being allowed or authorized by the user, the head-mounted display device or 3D screen interactive device captures a face image of the user through the camera. For example, the camera may be a depth sensor (depth camera), a binocular camera, a monocular camera, LiDAR, and so on.

For example, a face image of the user may be captured by a monocular camera, and the face image is a two-dimensional face image. The two-dimensional face image may describe a facial feature belonging to the user. By performing an iterative optimization on the initial three-dimensional face template using the facial feature from the two-dimensional face image, it is possible to obtain a target three-dimensional face template that may indicate the facial feature of the user.

In step S130, a current face pose of the target object is determined according to a corresponding relationship between a current face image of the target object and the target three-dimensional face template.

For example, the current face image of the target object may be a two-dimensional face image captured by the camera at current time instant. A current facial position of the target object may be estimated according to a corresponding relationship between the two-dimensional face image and a same part in the target three-dimensional face template. For example, according to an image information about a pupil part of the target object in the current face image of the target object, a pose of the corresponding pupil part is estimated in the target three-dimensional face template.

A face pose determined in the target three-dimensional face template is a face pose in a target coordinate system where the user is located. The head-mounted display device or 3D screen interactive device may perform a face pose estimation on the user by using the target face template and determine a face pose in a camera coordinate system where the camera is located.

For example, the head-mounted display device or 3D screen interactive device may determine a current face pose of the user, such as an information of facial orientation and facial expression, according to the face pose data in the camera coordinate system, and provide an interactive service for the user based on the current face pose of the user.

For example, the head-mounted display device or 3D screen interactive device may perform a face pose estimation by using the target face template through a pose estimation algorithm. For example, the pose estimation algorithm may include point cloud-based 3D object detection, point cloud-based template matching, and single image-based Perspective-n-Points (PNP) pose estimation algorithm.

For example, a real-time pose of pupils in the face may be determined in the face pose in the camera coordinate system. The 3D screen interactive device may adjust opening and closing of internal gratings of the screen according to the real-time pose of the pupils, and provide the user with an optimal glasses-free 3D viewing effect in the current viewing pose.

According to the embodiments of the present disclosure, an iterative optimization may be performed on the initial three-dimensional face template by using a real-time face image of the user, so as to obtain the target three-dimensional face template that may indicate the current face pose feature of the feature. By using the target three-dimensional face template, it is possible to accurately determine the current face pose of the user, reduce an error of the face pose, and provide a better 3D visual effect for the user.

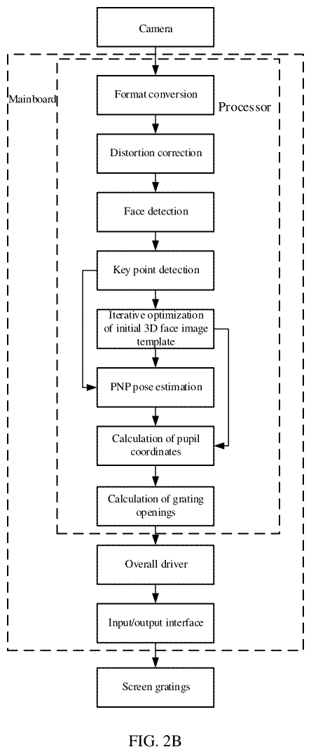

FIG. 2A shows an application scenario diagram of the method of processing the image according to the embodiments of the present disclosure. FIG. 2B shows a flowchart diagram of the method of processing the image according to the embodiments of the present disclosure. FIG. 2C shows a schematic diagram of a distribution of key points in a face image according to the embodiments of the present disclosure.

As shown in FIG. 2A, when a 3D screen interactive device 220 is viewed by a user 210, a camera 230 installed on the 3D screen interactive device 220 captures a face image of the user 210. The face image captured by the camera 230 is a two-dimensional face image. The camera 230 sends the two-dimensional face image to the 3D screen interactive device 230, and the 3D interactive device 220 performs an iterative optimization on an initial three-dimensional face model according to the two-dimensional face image, so as to obtain a target three-dimensional face template corresponding to the user 210. The 3D screen interactive device 220 performs a face pose estimation on the user 210 by using the target three-dimensional face template to obtain a three-dimensional face pose in a camera coordinate system, and provides a 3D visual service for the user 210 according to the three-dimensional face pose.

Referring to FIG. 2B, FIG. 2B shows a schematic diagram of, for example, the 3D screen interactive device 220 processing an image.

As shown in FIG. 2B, the 3D screen interactive device 220 acquires the two-dimensional face image of the user from the camera 210, and the two-dimensional face image is processed by a mainboard of the 3D screen interactive device 220 to obtain a three-dimensional face pose in the camera coordinate system. A control signal is sent to a screen grating based on the three-dimensional face pose in the camera coordinate system, so as to control the opening and closing of the screen grating.

For example, the mainboard may include an Access Point (AP) mainboard, and the processing operations are performed by a processor CPU on the mainboard.

For example, a format of the two-dimensional face image from the camera may be converted by the CPU from an NV21 format image to a Mat format image. The CPU performs a distortion correction on the Mat format image to obtain a corrected face image, and then determines a plurality of two-dimensional target key points from the corrected face image by using a key point detection algorithm.

A calculation principle of the pose estimation algorithm is based on an ideal camera model, and a pose estimation is performed in a camera model without distortion. Typically, a camera may have a tangential distortion caused by lens not being completely parallel to an image screen, and a radial distortion caused by light bending.

The present disclosure provides a method of correcting an image distortion.

For example, a distortion correction may be performed on the face image according to Equation (1).

$$\{ \begin{matrix}{x}_{0} = x ( 1 + {k}_{1} {r}^{2} + {k}_{2} {r}^{4} + {k}_{3} {r}^{6} ) \\ {y}_{0} = y ( 1 + {k}_{1} {r}^{2} + {k}_{2} {r}^{4} + {k}_{3} {r}^{6} ) \\ {x}_{0} = x + [ 2 {p}_{1} x y + {p}_{2} ( {r}^{2} + 2 {x}^{2} ) ] \\ {x}_{0} = x + [ 2 {p}_{1} x y + {p}_{2} ( {r}^{2} + 2 {x}^{2} ) ]\end{matrix} \qquad ( 1 )$$

x₀ and y₀ respectively represent coordinate values of any coordinate point on an uncorrected face image on x-axis and y-axis of a pixel coordinate system, and x and y respectively represent coordinate values of any coordinate point on the corrected face image on x-axis and y-axis of the pixel coordinate system. The pixel coordinate system is a coordinate system where the two-dimensional face image captured by the camera is located.

r represents a distance between a center point of the face image and the coordinate point (x, y), r²=x²+y². The further away the point is from the center point on the face image, the greater the distortion of the point.

k₁, k₂ and k₃ are radial distortion coefficients, and p₁ and p₂ are tangential distortion coefficients. For example, k₁, k₂, k₃, p₁ and p₂ are fixed parameters of the camera. Those skilled in the art may acquire the fixed parameters of the camera by any means in the art.

When determining the two-dimensional target key points, the CPU needs to first perform a face detection on the Mat format image to determine a facial region in the Mat format image, and then perform a key point detection on an image in the facial region through a facial key point detection algorithm, so as to obtain a plurality of two-dimensional target key points.

The two-dimensional target key points may include 5 key points, 21 key points, 49 key points, or 68 key points. According to actual detection needs, other numbers of key points may also be selected, such as tens of thousands of key points. For example, the key points may be distributed at eyes, nose tip, left and right corners of mouth, eyebrows and other regions. The plurality of key points need to be distributed on a plurality of planes, so that the key points may describe the facial feature more accurately.

For example, with more key points, an accuracy of a result of pose estimation solving may be improved, but a detection and solving time may also be increased. In the embodiments of the present disclosure, 68 facial key points are used, which may simultaneously ensure the real-time and accuracy requirements of the algorithm. A distribution and order of the 68 facial key points are shown in FIG. 2C.

For example, the face detection algorithm and the key point detection algorithm may be implemented using CascadeClassifier class and Facemark class in OpenCV library. CascadeClassifier may perform a key point detection based on cascaded classifiers for Haar, LBP, HOG and other features. Facemark may perform a key point detection based on local binary feature LBF and cascaded random forest global linear regression. The face detection algorithm and the key point detection algorithm may also be replaced by other algorithms (faster or more accurate algorithms) according to actual needs. The face detection algorithm and the key point detection algorithm are not limited in the present disclosure.

Since there may be significant differences in coordinates of three-dimensional facial key points of different human individuals (such as race, age, gender, etc.) and the face is a typical non-rigid object, the three-dimensional coordinates of facial key points in the target coordinate system may change at any time. After obtaining the 68 two-dimensional target key points, the CPU may perform an iterative optimization on the initial three-dimensional face template to obtain an optimal target three-dimensional face template. The target three-dimensional face template has a best matching effect with the current facial feature of the user.

The CPU may perform a face pose estimation on the user according to the target three-dimensional face template and the PNP pose estimation algorithm so as to obtain a three-dimensional face pose of the face image in the camera coordinate system, and calculate the coordinates of left and right pupils of the user according to the pose in the camera coordinate system. For example, the three-dimensional face pose may be described by 68 three-dimensional key points corresponding to the 68 two-dimensional target key points.

For example, as shown in FIG. 2C, the 68 facial key points do not contain positions of pupil centers. The CPU may calculate a centroid (mean) of the 3D coordinates of six key points (key points 36˜41) around the left eye of the face to determine the 3D coordinate P/of the left eye pupil of the user in the camera coordinate system, calculate a centroid of the 3D coordinates of six key points (key points 42˜47) around the right eye of the face to determine the coordinates Pᵣ of the right eye pupil of the user in the camera coordinate system, and calculate a grating opening and closing sequence that may present the optimal glasses-free 3D effect for the user according to the pupil coordinates Pₗ and Pᵣ and a grating layout on the screen. The grating opening and closing sequence may include a sequence composed of 0 and 1, where 0 represents the corresponding grating is closed and 1 represents the corresponding grating is open. The CPU transmits the grating opening and closing sequence to an overall driver of the mainboard, and the overall driver controls an output interface of the mainboard to output corresponding high and low levels, so as to control the grating opening and closing on the screen. For example, the output interface may be a General-purpose input/output (GPIO) interface.

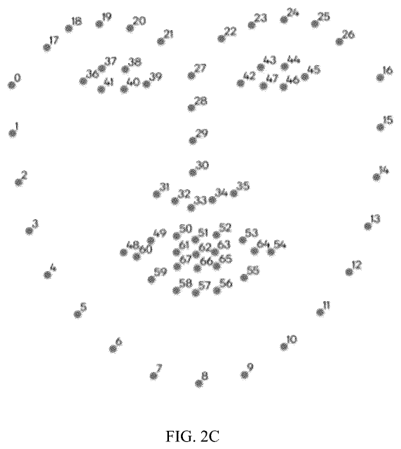

FIG. 3 shows a flowchart of constructing an initial three-dimensional face template according to the embodiments of the present disclosure.

As shown in FIG. 3, step S110 of constructing the initial three-dimensional face template by using the plurality of sample face images may include step S310 to step S340 as follows.

In step S310, a plurality of three-dimensional sample key points are acquired respectively from each of the plurality of sample face images.

In step S320, an average three-dimensional face template is determined according to the plurality of three-dimensional sample key points of the plurality of sample face images.

In step S330, a feature matrix of the plurality of sample face images is determined by using the average three-dimensional face template.

In step S340, the initial three-dimensional face template is constructed according to an iteration parameter, the average three-dimensional face template and the feature matrix.

In the embodiments of the present disclosure, LS3D-W dataset may be used as a data source of the average face template to acquire a plurality of sample face images. 68 three-dimensional sample key points are acquired from each sample face image. It should be noted that the 68 three-dimensional sample key points from each sample face image are distributed in the same way. For example, the 68 three-dimensional sample key points from each sample face image include six key points (key points 36˜41) around the left eye of the face and six key points (key points 42˜47) around the right eye of the face.

Each key point includes three coordinate values (X, Y and Z) of the key point in the target coordinate system. An average value of all key points at a same potion of the face images may be calculated to determine an average three-dimensional face template mean_shape. The average three-dimensional face template mean_shape includes three coordinate values of 68 average key points, and a unit of the coordinate value may be mm.

The three-dimensional face template mean_shape may be a column vector [X₀,X₁, . . . , X₆₇,Y₀,Y₁ . . . , Y₆₇,Z₀,Z₁ . . . ,Z₆₇]^{T} with a dimension of 204*1, where X₀, Y₀ and Z₀ respectively represent the coordinate values of a first average key point.

In the embodiments of the present disclosure, determining the feature matrix of the plurality of sample face images by using the average three-dimensional face template may include: performing a decentralization on the plurality of three-dimensional sample key points of the plurality of sample face images by using the average three-dimensional face template, so as to obtain a covariance matrix; calculating a plurality of feature values of the covariance matrix and a plurality of feature vectors corresponding to the plurality of feature values; determining a plurality of valid feature vectors from the plurality of feature vectors according to contribution values of the plurality of feature values to a linear projection in the covariance matrix, where a sum of the contribution values of the plurality of feature values corresponding to the plurality of valid feature vectors is greater than a predetermined contribution value; and constructing the feature matrix according to the plurality of valid feature vectors.

For example, the facial key point data in the LS3D-W dataset may be analyzed using a principal component analysis algorithm (PCA) to reduce a linear dimension of the key point data. For example, high-dimensional data may be mapped to a low-dimensional space through a linear projection, so that more original data point characteristics may be retained using fewer data dimensions.

For example, a difference calculation may be performed on the 68 key points of each sample face image and the 68 average key points of the average three-dimensional face template mean_shape to achieve decentralization (mean removal). A covariance matrix is constructed from the decentralized 68 key points of each sample face image. A plurality of feature values of the covariance matrix and a plurality of feature vectors corresponding to the feature values may be solved.

Each feature value of the covariance matrix represents the contribution value to the linear projection. The valid feature values are selected from the plurality of feature values. For example, according to an order of numeric values of the feature values, a sum of top N feature values may be calculated. When it is determined that a proportion of the sum of the top N feature values to a sum of all feature values is greater than or equal to 99%, the N feature values are selected as valid feature values. The predetermined contribution value may be 99%. Those skilled in the art may also set other contribution values according to actual needs, which is not limited in the present disclosure. In this case, N=num, and the top num feature values are selected as valid feature values, where N is a positive integer. num represents a minimum feature dimension of the 204-dimensional features of the three-dimensional face image. The feature vectors corresponding to the top num feature values are valid feature vectors. The num valid feature vectors form a feature matrix pv, and the dimension of the feature matrix is 204*num.

In the embodiments of the present disclosure, the initial three-dimensional face template current_shape_3D may be expressed by Equation (2).

$$current\_shape \_ 3 D = mean\_shape + pv \cdot params \qquad ( 2 )$$

params is the iteration parameter. A changing feature of the face image at different times may be represented by the iteration parameter params.

The dimension of the initial three-dimensional face template current_shape_3D is 204*1, and the dimension of the iteration parameter params is num*1.

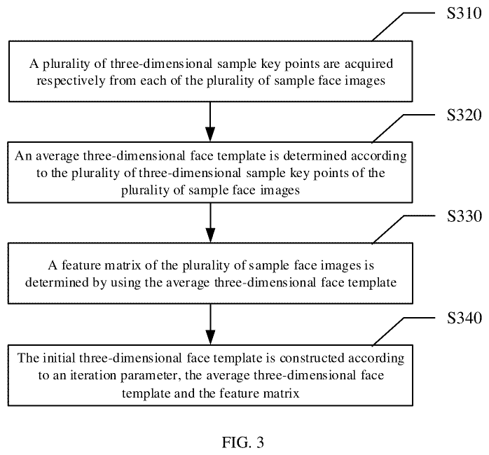

FIG. 4 shows a flowchart of iterating the initial three-dimensional face template according to the embodiments of the present disclosure.

As shown in FIG. 4, step S120 of performing an iterative optimization on the initial three-dimensional face template by using the face image of the target object so as to obtain the target three-dimensional face template may include step S410 to step S440 as follows.

In step S410, a plurality of two-dimensional target key points are acquired from the face image of the target object.

In step S420, a plurality of three-dimensional key points are determined from the initial three-dimensional face template.

In step S430, the plurality of three-dimensional key points are projected into a plurality of two-dimensional projection key points.

In step S440, an average error between the plurality of two-dimensional projection key points and the plurality of two-dimensional target key points is calculated.

In step S450, an iterative optimization is performed on the initial three-dimensional face template according to the average error, so as to obtain the target three-dimensional face template.

In the embodiments of the present disclosure, the two-dimensional target key points may be obtained from the distortion-corrected face image. For example, 68 two-dimensional target key points may be acquired from the distortion-corrected face image. The plurality of three-dimensional key points determined from the initial three-dimensional face template may be unknown key points. For example, the coordinate values of the three-dimensional key points may be a function (X, Y, Z) of the iteration parameter params.

For example, the plurality of three-dimensional key points from the initial three-dimensional face template may be expressed by Equation (3).

$$current\_shape \_ 3 D = [ \begin{matrix}X 0 & X 1 & … & X 67 & Y 0 & Y 1 & … & Y 67 & Z 0 & Z 1 & … & Z 67 ]\end{matrix} \qquad ( 3 )$$

By changing Equation (3), a matrix with a dimension of 3*68 may be obtained, which is expressed by Equation (4).

$$current\_shape \_ 3 D = [ \begin{matrix}X 0 & X 1 & … & X 67 \\ Y 0 & Y 1 & … & Y 67 \\ Z 0 & Z 1 & … & Z 67\end{matrix} ] \qquad ( 4 )$$

In the embodiments of the present disclosure, projecting the plurality of three-dimensional key points into a plurality of two-dimensional projection key points may include: constructing a weak perspective projection model params global according to the coordinate values of the three-dimensional key points, a scaling ratio, a coordinate system rotation matrix, and a center point offset vector of the pixel coordinate system; and projecting the plurality of three-dimensional key points into a plurality of two-dimensional projection key points by using the weak perspective projection model.

For example, the weak perspective projection model may be expressed by Equation (5).

$$params\_global = [ \begin{matrix}scale & {R}_{x} & {R}_{y} & {R}_{z} & {t}_{x} & {t}_{y}\end{matrix} ] \qquad ( 5 )$$

where scale represents the scaling ratio, Rₓ represents a rotation amount of the x-axis of the target coordinate system with respect to the x-axis of the camera coordinate system, R_{y} represents a rotation amount of the y-axis of the target coordinate system with respect to the y-axis of the camera coordinate system, R_{z} represents a rotation amount of the z-axis of the target coordinate system with respect to the z-axis of the camera coordinate system, and tₓ and t_{y} respectively represent the offset vectors of the origin of the pixel coordinate system with respect to the origin of the camera coordinate system on the x-axis and y-axis.

For example, the origin of the pixel coordinate system may be located at an upper left corner of the two-dimensional face image, and the origin of the camera coordinate system may be located at a center of an optical axis of the camera. Accordingly, a coordinate point on the optical axis of the camera, such as coordinate point (0,0), may have pixel coordinates (tₓ, t_{y}) in the pixel coordinate system.

In the embodiments of the present disclosure, projecting the plurality of three-dimensional key points from the initial three-dimensional face template into a plurality of two-dimensional projection key points may be expressed by Equation (6).

$$[ \begin{matrix}x \\ y\end{matrix} ] = scale \cdot [ \begin{matrix}{R}_{00} & {R}_{01} & {R}_{02} \\ {R}_{10} & {R}_{11} & {R}_{21}\end{matrix} ] \cdot [ \begin{matrix}X \\ Y \\ Z\end{matrix} ] + [ \begin{matrix}{t}_{x} \\ {t}_{y}\end{matrix} ] \qquad ( 6 )$$

For example, x and y respectively represent the coordinate values of the two-dimensional projection key points on the x-axis and y-axis of the pixel coordinate system, and X, Y and Z respectively represent the coordinate values of the three-dimensional key points on the x-axis, y-axis and z-axis of the target coordinate system. For example, X, Y and Z may represent the coordinate values of the 68 average key points of the initial three-dimensional face template.

$$[ \begin{matrix}{R}_{00} & {R}_{01} & {R}_{02} \\ {R}_{10} & {R}_{11} & {R}_{21}\end{matrix} ]$$

represents a rotation matrix of the target coordinate system with respect to the camera coordinate system.

Equation (4) may be substituted into Equation (6) to obtain Equation (7).

$$current\_shape \_ 2 D = scale \cdot [ \begin{matrix}{R}_{00} & {R}_{01} & {R}_{02} \\ {R}_{10} & {R}_{11} & {R}_{21}\end{matrix} ] \cdot current\_shape \_ 3 D + [ \begin{matrix}{t}_{x} \\ {t}_{y}\end{matrix} ] \qquad ( 7 )$$

Equation (7) shows projecting the three-dimensional key points from the initial three-dimensional face template current_shape_3D onto a plane of the pixel coordinate system to obtain a two-dimensional projection key point matrix current_shape_2D with a dimension of 2*68. Since the three-dimensional key point from the initial three-dimensional face template current_shape_3D is a function (X, Y, Z) of the iteration parameter params, the two-dimensional projection key point in the two-dimensional projection key point matrix current_shape_2D is also a function (x, y) of the iteration parameter params.

For example, the two-dimensional projection key point matrix current_shape_2D may be expressed by Equation (8).

$$current\_shape \_ 2 D = [ \begin{matrix}x 0 & x 1 & … & x 67 \\ y 0 & y 1 & … & y 67\end{matrix} ] \qquad ( 8 )$$

For example, the two-dimensional target key point matrix landmarks_2D formed by the 68 two-dimensional target key points acquired from the distortion-corrected face image may be expressed by Equation (9).

$$landmarks\_ 2 D = [ \begin{matrix}x {0}^{′} & x {1}^{′} & … & x {67}^{′} \\ y {0}^{′} & y {1}^{′} & … & y {67}^{′}\end{matrix} ] \qquad ( 9 )$$

In the embodiments of the present disclosure, calculating the average error between the plurality of two-dimensional projection key points and the plurality of two-dimensional target key points includes: calculating a re-projection error according to the plurality of two-dimensional projection key points and the plurality of two-dimensional target key points; and calculating the average error according to the re-projection error.

Calculating the re-projection error projₑᵣᵣ between the plurality of two-dimensional projection key points and the plurality of two-dimensional target key points according to the two-dimensional projection key point matrix current_shape_2D and the two-dimensional target key point matrix landmarks_2D may be expressed by Equation (10).

$${proj}_{err} = landmarks\_ 2 D - current\_shape \_ 2 D = [ \begin{matrix}{Error\_X}_{0} & {Error\_X}_{1} & … & {Error\_X}_{67} \\ {Error\_Y}_{0} & {Error\_Y}_{1} & … & {Error\_Y}_{67}\end{matrix} ] \qquad ( 10 )$$

Calculating the average error error according to the re-projection error projₑᵣᵣ may be expressed by Equation (11).

$$error = \frac{1}{68} {\sum }_{i = 0}^{67} {‖ {proj}_{err} ‖}^{2} \qquad ( 11 )$$

The re-projection error is expressed as

$${proj}_{err} = landmarks\_ 2 {D}_{i} - current\_shape \_ 2 {D}_{i} = [ \begin{matrix}{Error\_X}_{i} \\ {Error\_Y}_{i}\end{matrix} ] ,$$

where Error_Xᵢ represents a re-projection error between a coordinate value of an i^{th} two-dimensional projection key point and a coordinate value of an i^{th} two-dimensional target key point on the x-axis, and Error_Yᵢ represents a re-projection error between a coordinate value of the i^{th} two-dimensional projection key point and a coordinate value of the i^{th} two-dimensional target key point on the y-axis. In this case, the average error error is a function of the iteration parameter params.

In the embodiments of the present disclosure, the accuracy of the target three-dimensional face template may be measured by the re-projection error, and the re-projection error is related to the iteration parameter params and the parameter of the weak perspective projection model params global. When error reaches a convergence condition through continuous iterative optimization, the iteration parameter params is the optimal iteration parameter, and at this time, the target three-dimensional face template current_shape_3D is the optimal target three-dimensional face template.

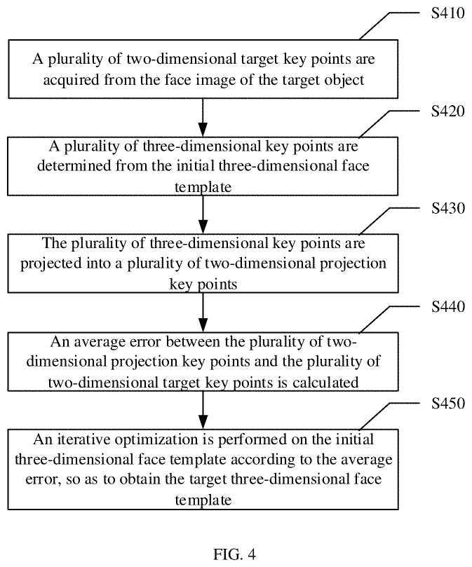

FIG. 5 shows a flowchart of iterating the initial three-dimensional face template according to other embodiments of the present disclosure.

As shown in FIG. 5, step S450 of performing an iterative optimization on the initial three-dimensional face template according to the average error so as to obtain the target three-dimensional face template may include step S551 to step S556 as follows.

In step S551, an iteration model is constructed according to the weak perspective projection model and the iteration parameter.

In step S552, a mapping function between the iteration model and the plurality of two-dimensional projection key points is determined.

In step S553, a Jacobi matrix of the mapping function is calculated to obtain iteratively-optimized two-dimensional iterative key points.

In step S554, the average error is calculated according to the two-dimensional iterative key points and the plurality of two-dimensional target key points from the face image.

In step S555, when it is determined that the average error does not meet the convergence condition, a parameter of the iteration model is updated in a descent gradient direction of the Jacobi matrix to obtain an updated iteration model, and the process returns to the operation in step S552.

In step S556, when it is determined that the average error meets the convergence condition, the iteration parameter is determined, and the target three-dimensional face template is constructed according to the iteration parameter.

In the embodiments of the present disclosure, the mapping function may be expressed by Equation (12).

$$F ( [ \begin{matrix}scale \\ {R}_{x} \\ {R}_{y} \\ {R}_{z} \\ {t}_{x} \\ {t}_{y} \\ params\end{matrix} ] ) = [ \begin{matrix}current\_shape \_ 2 D\_x \\ current\_shape \_ 2 D\_y\end{matrix} ] \qquad ( 12 )$$

$$F ( [ \begin{matrix}scale \\ {R}_{x} \\ {R}_{y} \\ {R}_{z} \\ {t}_{x} \\ {t}_{y} \\ params\end{matrix} ] )$$

is an iteration model for the weak perspective projection model and the iteration parameter.

$$[ \begin{matrix}current\_shape \_ 2 D\_x \\ current\_shape \_ 2 D\_y\end{matrix} ]$$

is a coordinate value matrix of the two-dimensional projection key points, where current_shape_2D_x is an x-axis coordinate value matrix of the 68 two-dimensional projection key points, and current_shape_2D_y is the y-axis coordinate value matrix of the 68 two-dimensional projection key points.

For example,

$$[ \begin{matrix}current\_shape \_ 2 D\_x \\ current\_shape \_ 2 D\_y\end{matrix} ] = current\_shape \_ 2 D = [ \begin{matrix}x 0 & x 1 & … & x 67 \\ y 0 & y 1 & … & y 67\end{matrix} ] .$$

For example, the iteration model may be iteratively optimized using the Jacobi matrix J, and the iteratively optimized two-dimensional iterative key points may be determined in the optimized iteration model.

For example, the Jacobi matrix J of the iteration model may have a dimension of 136*(num+6). The Jacobi matrix J may be obtained by taking partial derivatives of the weak perspective projection model parameters scale, Rₓ, R_{y}, R_{z}, tₓ and t_{y} on the right side of Equation (7) and taking partial derivatives of the weak perspective projection model parameter params on the right side of Equation (12).

The Jacobi matrix J may be expressed by Equation (13) to Equation (20).

$$\frac{\partial ( current\_shape \_ 2 D\_x )}{\partial scale} = current\_shape \_ 3 D \cdot {[ \begin{matrix}{R}_{00} & {R}_{01} & {R}_{02}\end{matrix} ]}^{T} \qquad ( 13 )$$

$$\frac{\partial ( current\_shape \_ 2 D\_y )}{\partial scale} = current\_shape \_ 3 D \cdot {[ \begin{matrix}{R}_{10} & {R}_{11} & {R}_{12}\end{matrix} ]}^{T} \qquad ( 14 )$$

$$[ \begin{matrix}\frac{\partial ( current\_shape \_ 2 D\_x )}{\partial {R}_{x}} \\ \frac{\partial ( current\_shape \_ 2 D\_x )}{\partial {R}_{y}} \\ \frac{\partial ( current\_shape \_ 2 D\_x )}{\partial {R}_{y}}\end{matrix} ] = scale \cdot {( [ \begin{matrix}0 & {R}_{13} & - {R}_{12} \\ - {R}_{13} & 0 & {R}_{11} \\ {R}_{12} & - {R}_{11} & 0\end{matrix} ] \cdot current\_shape \_ 3 {D}^{T} )}^{T} \qquad ( 15 )$$

$$[ \begin{matrix}\frac{\partial ( current\_shape \_ 2 D\_y )}{\partial {R}_{x}} \\ \frac{\partial ( current\_shape \_ 2 D\_y )}{\partial {R}_{y}} \\ \frac{\partial ( current\_shape \_ 2 D\_y )}{\partial {R}_{y}}\end{matrix} ] = scale \cdot {( [ \begin{matrix}0 & {R}_{23} & - {R}_{22} \\ - {R}_{23} & 0 & {R}_{21} \\ {R}_{22} & - {R}_{21} & 0\end{matrix} ] \cdot current\_shape \_ 3 {D}^{T} )}^{T} \qquad ( 16 )$$

$$[ \begin{matrix}\frac{\partial ( current\_shape \_ 2 D\_x )}{\partial {t}_{x}} \\ \frac{\partial ( current\_shape \_ 2 D\_x )}{\partial {t}_{y}}\end{matrix} ] = [ \begin{matrix}1 \\ ⋮ \\ 1 \\ 0 \\ ⋮ \\ 0\end{matrix} ] \qquad ( 17 )$$

$$[ \begin{matrix}\frac{\partial ( current\_shape \_ 2 D\_y )}{\partial {t}_{x}} \\ \frac{\partial ( current\_shape \_ 2 D\_y )}{\partial {t}_{y}}\end{matrix} ] = [ \begin{matrix}0 \\ ⋮ \\ 0 \\ 1 \\ ⋮ \\ 1\end{matrix} ] \qquad ( 18 )$$

$$[ \frac{\partial ( current\_shape \_ 2 D\_x )}{\partial params} ] = scale ( {R}_{00} \cdot pv\_X + {R}_{01} \cdot pv\_Y + {R}_{02} \cdot pv\_Z ) \qquad ( 19 )$$

$$[ \frac{\partial ( current\_shape \_ 2 D\_y )}{\partial params} ] = scale ( {R}_{10} \cdot pv\_X + {R}_{11} \cdot pv\_Y + {R}_{12} \cdot pv\_Z ) \qquad ( 20 )$$

Equation (13) and Equation (14) form a first column of the Jacobi matrix J, Equation (15) and Equation (16) form a second column to a fourth column of the Jacobi matrix J, Equation (17) and Equation (18) form a fifth column and a sixth column of the Jacobi matrix J, and Equation (19) and Equation (20) form a seventh column to a (num+6)^{th} column of the Jacobi matrix J.

In Equation (19) and Equation (20), pv_X represents a first row to a 68^{th} row of the feature matrix pv, pv_Y represents a 69^{th} row to a 138^{th} row of the feature matrix pv, and pv_Z represents a 139^{th} row to a 204^{th} row of the feature matrix pv. pv_X, pv_Y and pv_Z have a dimension of 68*num.

For example, during a first iteration of the iteration model, an initial value may be set for the weak perspective projection model parameter. For example, Rₓ=0, R_{y}=0, R_{z}=0. scale represents a ratio of a size of the average three-dimensional face template to a facial region detected in the face detection algorithm module. tₓ and t_{y} are determined by the center coordinates of the face region on the plane of the two-dimensional face image, and the initial values of tₓ and t_{y} may both be 0.

The re-projection error projₑᵣᵣ may be calculated after each iteration optimization, and the iteration model may be updated according to the re-projection error projₑᵣᵣ after each iteration optimization. Updating the iteration model includes: calculating a parameter variation of the iteration model according to the descent gradient direction of the Jacobi matrix and the average error; and updating the parameter of the iteration model according to the parameters variation to obtain the updated iteration model.

For example, when the average error does not meet the convergence condition, a movement direction (descent gradient direction) of the Jacobi matrix J may be determined according to a gradient descent principle, and the parameter variation of the iteration model may be calculated. The iteration model may be updated according to the parameter variation, and the mapping function between the iteration model and the two-dimensional projection key points may be re-determined.

For example, calculating the parameter variation delta of the iteration model may be expressed by Equation (21).

$$delta = 0.75 \cdot {J}^{T} \cdot {proj}_{err} \qquad ( 21 )$$

For example, updating the iteration model may be expressed by Equation (22).

$$[ \begin{matrix}{scale}^{′} \\ {{R}_{x}}^{′} \\ {{R}_{y}}^{′} \\ {{R}_{z}}^{′} \\ {{t}_{x}}^{′} \\ {{t}_{y}}^{′} \\ {params}^{′}\end{matrix} ] = [ \begin{matrix}scale \\ {R}_{x} \\ {R}_{y} \\ {R}_{z} \\ {t}_{x} \\ {t}_{y} \\ params\end{matrix} ] - delta \qquad ( 22 )$$

$$where [ \begin{matrix}{scale}^{′} \\ {{R}_{x}}^{′} \\ {{R}_{y}}^{′} \\ {{R}_{z}}^{′} \\ {{t}_{x}}^{′} \\ {{t}_{y}}^{′} \\ {params}^{′}\end{matrix} ]$$

represents the updated iteration model, and

$$[ \begin{matrix}scale \\ {R}_{x} \\ {R}_{y} \\ {R}_{z} \\ {t}_{x} \\ {t}_{y} \\ params\end{matrix} ]$$

represents the un-updated iteration model.

For example, the re-projection error projₑᵣᵣ may be calculated after each iterative optimization, and the average error error may be calculated according to the re-projection error projₑᵣᵣ. When it is determined that the average error error almost has no change, it is considered that the average error error converges.

For example, it is considered that the average error error converges when an average projection error current_error obtained after a complete of the iterative optimization and an average projection error last_error obtained after a complete of a previous iteration optimization meet Equation (23).

$$current\_error > 0.999 \cdot last\_error \qquad ( 23 )$$

When it is determined that the average errors meet the convergence condition, an iteration parameter params′ may be determined, and the target three-dimensional face template may be constructed according to the iteration parameter params′. The target three-dimensional face template may be current_shape_3D=mean_shape+pv·params′.

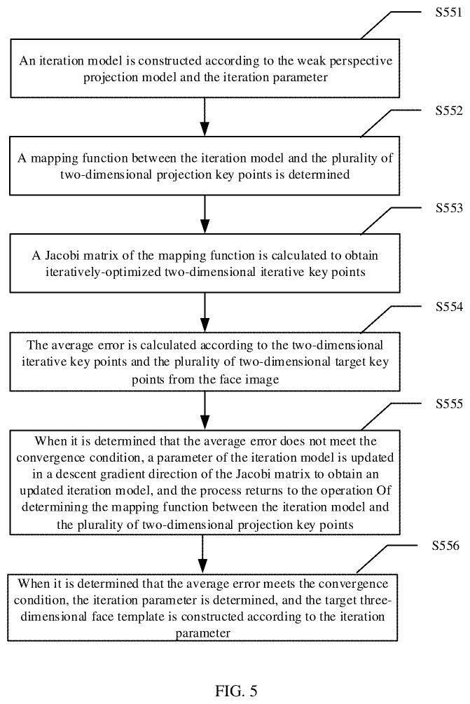

FIG. 6A shows a flowchart of determining a face pose of a target object according to the embodiments of the present disclosure. FIG. 6B shows a schematic diagram of a transformation from a target coordinate system to a camera coordinate system according to the embodiments of the present disclosure.

As shown in FIG. 6A, step S130 of determining the current face pose of the target object according to the corresponding relationship between the current face image of the target object and the target three-dimensional face template may include step S610 to step S640 as follows.

In step S610, a plurality of predetermined three-dimensional key points of the target object are determined from a plurality of three-dimensional key points of the target three-dimensional face template.

In step S620, a transformation matrix between the camera coordinate system and the target coordinate system is determined according to a corresponding relationship between a pixel coordinate system where the face image from the camera is located and the target coordinate system.

In step S630, the plurality of predetermined three-dimensional key points are converted into a plurality of target three-dimensional key points according to the transformation matrix, where the plurality of target three-dimensional key points are located in the camera coordinate system.

In step S640, the current face pose of the target object is determined according to the plurality of target three-dimensional key points.

For example, the plurality of predetermined three-dimensional key points correspond to a plurality of specified two-dimensional key points of the current face image of the target object. The plurality of specified two-dimensional key points of the current face image may be located in a specified facial region that requires a face pose estimation. For example, the plurality of specified two-dimensional key points may be located in a region around the eyes of the user. According to the plurality of specified two-dimensional key points around the eyes, a plurality of predetermined three-dimensional key points around the eyes of the user may be determined in a corresponding region of the target three-dimensional face template. The positions of the pupils of the user may be determined according to the plurality of predetermined key points around the eyes of the user. The plurality of predetermined three-dimensional key points are located in the target coordinate system.

Through the PNP pose estimation algorithm, the two-dimensional coordinates in the pixel coordinate system may correspond to the three-dimensional coordinates in the target coordinate system respectively, thereby solving a transformation matrix

$$[ \begin{matrix}{R}_{t} & t \\ 0 & 1\end{matrix} ]$$

to transform the target coordinate system W to the camera coordinate system C.

As shown in FIG. 6B, a coordinate origin O_{w} of the target coordinate system W is transformed into a coordinate origin O_{C} of the camera coordinate system through the transformation matrix, and a coordinate point Pᵢ of the target coordinate system W is transformed into a coordinate point pᵢ of the camera coordinate system through the transformation matrix.

For example, the transformation matrix between the camera coordinate system and the target coordinate system may be determined by Equation (24).

$$c [ \begin{matrix}x \\ y \\ 1\end{matrix} ] = K \cdot [ \begin{matrix}{R}_{t} & t \\ 0 & 1\end{matrix} ] \cdot [ \begin{matrix}X \\ Y \\ Z \\ 1\end{matrix} ] \qquad ( 24 )$$

where c represents a scale of the camera, x and y respectively represent the coordinate values of the two-dimensional projection key points on the x-axis and y-axis of the pixel coordinate system, X, Y and Z respectively represent the coordinate values of the predetermined three-dimensional key points on the x-axis, y-axis and z-axis of the target coordinate system, and K is a camera internal parameter matrix.

According to the characteristics of the transformation matrix, the transformation matrix includes a rotation angle Rₜ of three axes (x-axis, y-axis and z-axis) and a translation amount t in three axis directions. Since the two-dimensional key points include 68 key points, an overdetermined system of equations including 2*68=136 equations may be constructed by the 68 key points. The rotation angle R, of three axes (x-axis, y-axis and z-axis) and the translation amount t in the three axis directions may be solved through the 136 equations.

For example, the overdetermined system of equations including 136 equations may be expressed by x=(A^{T}·A)⁻¹·A^{T}·b, where

$$x = [ \begin{matrix}{R}_{t} & t \\ 0 & 1\end{matrix} ] , A = K [ \begin{matrix}X \\ Y \\ Z \\ 1\end{matrix} ] , b = c [ \begin{matrix}x \\ y \\ 1\end{matrix} ] .$$

The least squares solution is solved for the overdetermined system of equations to avoid a detection error or excessive error of individual key point that may cause a deviation in a final face position estimation result.

The present disclosure further provides a verification method for verifying the accuracy of the target three-dimensional face template of the present disclosure.

For example, a depth sensor may be fixedly installed on a 3D screen interactive device, and a transformation matrix T between the depth sensor and an ordinary monocular camera of the 3D screen interactive device may be calibrated using tools such as Stereo Camera Calibrator toolbox in matlab or stereoCalibrate function in OpenCV library.

Assuming that at a particular time instant, the 3D coordinates of the user pupil in the camera coordinate system of the 3D screen interactive device are [x,y,z]^{T}, which may be transformed to coordinates [x′, y′, z′]^{T} in the depth sensor coordinate system. The transformation relationship between the two is expressed as follows.

$$[ \begin{matrix}{x}^{′} \\ {y}^{′} \\ {z}^{′} \\ 1\end{matrix} ] = T [ \begin{matrix}x \\ y \\ z \\ 1\end{matrix} ]$$

The 3D coordinates of the pupil acquired by the depth sensor are determined as true values, the 3D coordinates of the pupil obtained by the target three-dimensional face template determined in the embodiments of the present disclosure are converted into 3D coordinates in the depth sensor coordinate system through the matrix T, and the converted 3D coordinates may be compared with the true values to verify the accuracy of the target three-dimensional face template determined in the embodiments of the present disclosure.

A verification result shows that the 3D coordinates of the pupil obtained by the target three-dimensional face template determined in the embodiments of the present disclosure at different viewing distances have small errors in the x-axis, y-axis and z-axis directions, and the errors are stable.

The error may be introduced due to a calibration error in the transformation matrix between the depth sensor and the camera or an error in the facial key point detection. Since the error of the target three-dimensional face template determined in the embodiments of the present disclosure is stable, the error may be compensated by adding a fixed bias in practical use. The target three-dimensional face template determined in the embodiments of the present disclosure is reliable in terms of accuracy and stability, and has a practical value.

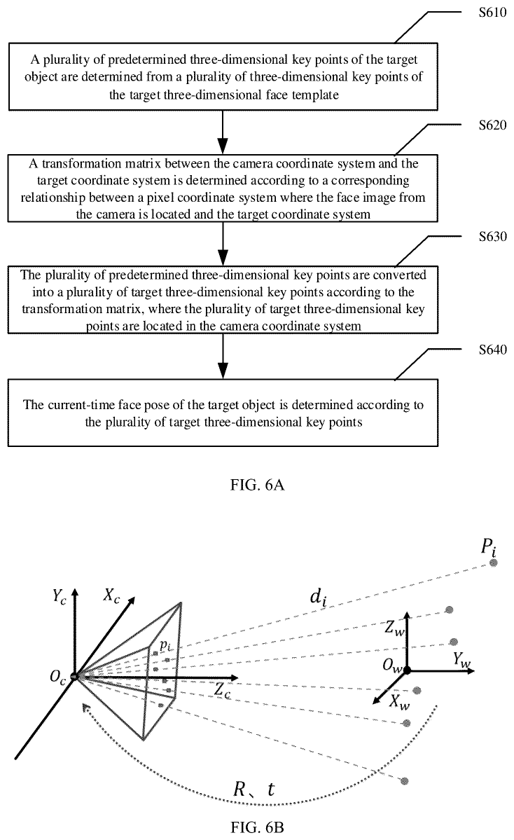

Based on the above-mentioned method of processing the image, the present disclosure further provides an apparatus of processing an image, which will be described in detail below with reference to FIG. 7.

FIG. 7 shows a structural block diagram of an apparatus of processing an image according to the embodiments of the present disclosure.

As shown in FIG. 7, an apparatus 700 of processing an image in such embodiments includes a construction module 710, an iteration module 720, and a determination module 730.

The construction module 710 is used to construct an initial three-dimensional face template by using a plurality of sample face images. In an embodiment, the construction module 710 may be used to perform operation S110 described above, which will not be repeated here.

The iteration module 720 is used to perform an iterative optimization on the initial three-dimensional face template by using a face image of a target object, so as to obtain a target three-dimensional face template. In an embodiment, the iteration module 720 may be used to perform operation S120 described above, which will not be repeated here.

The determination module 730 is used to determine a current face pose of the target object according to a corresponding relationship between a current face image of the target object and the target three-dimensional face template. In an embodiment, the determination module 730 may be used to perform operation S130 described above, which will not be repeated here.

According to the embodiments of the present disclosure, any number of the construction module 710, the iteration module 720 and the determination module 730 may be combined into one module for implementation, or any one of the modules may be divided into a plurality of modules. Alternatively, at least part of the functions of one or more of these modules may be combined with at least part of the functions of other modules and implemented in one module. According to embodiments of the present disclosure, at least one of the construction module 710, the iteration module 720 and the determination module 730 may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by hardware or firmware in any other reasonable manner of integrating or encapsulating the circuit, or may be implemented by any one of the three implementation modes of software, hardware and firmware or an appropriate combination thereof. Alternatively, at least one of the construction module 710, the iteration module 720 and the determination module 730 may be at least partially implemented as a computer program module that may perform corresponding functions when executed.

The present disclosure further provides an interactive device, including a camera, a processor, a driving circuit, an input/output interface, and a screen. The camera, the processor, the driving circuit, the input/output interface and the screen are electrically connected in sequence

The camera is used to acquire a face image of a target object, and send the face image to the processor.

The processor is used to perform an iterative optimization on an initial three-dimensional face template by using the face image so as to obtain a target three-dimensional face template. Then, the processor may perform a face pose estimation by using the target three-dimensional face template so as to obtain pupil coordinates of the target object. The processor may calculate a grating opening and closing sequence according to the pupil coordinates.

The driving circuit is used to receive the grating opening and closing sequence from the processor, and control the output interface to output the grating opening and closing sequence.

The screen is provided with an array of gratings. The screen is used to control opening and closing of a grating in the array of gratings according to the grating opening and closing sequence.

In the embodiments of the present disclosure, the interactive device is similar to the 3D screen interactive device 220 shown in FIG. 2B of the present disclosure, which will not be repeated here for simplicity.

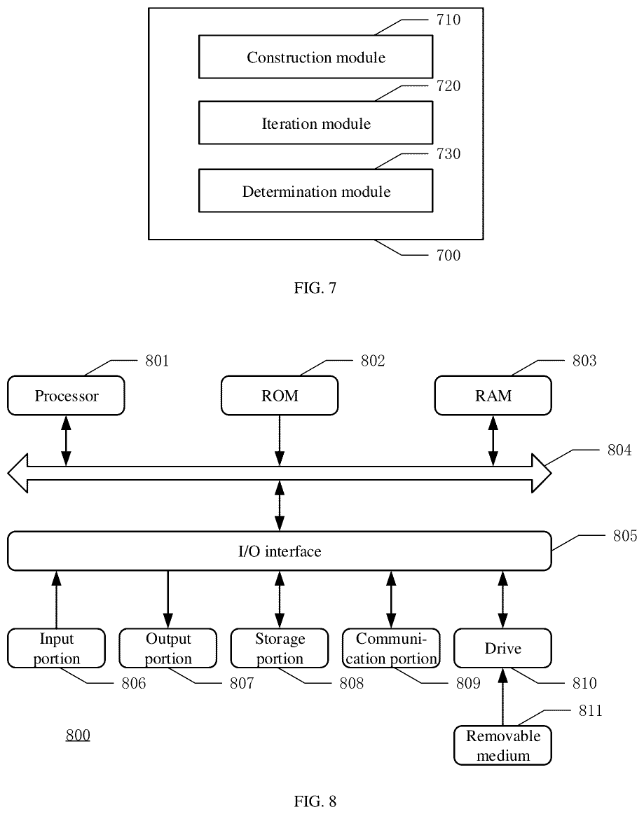

FIG. 8 shows a block diagram of an electronic device suitable for implementing the method of processing the image according to the embodiments of the present disclosure.

As shown in FIG. 8, an electronic device 800 according to the embodiments of the present disclosure includes a processor 801, which may execute various appropriate actions and processing according to the program stored in a read only memory (ROM) 802 or the program loaded into a random access memory (RAM) 803 from a storage portion 808. The processor 801 may, for example, include a general-purpose microprocessor (for example, CPU), an instruction set processor and/or a related chipset and/or a special-purpose microprocessor (for example, an application specific integrated circuit (ASIC)), and the like. The processor 801 may further include an on-board memory for caching purposes. The processor 801 may include a single processing unit or multiple processing units for executing different actions of the method flow according to embodiments of the present disclosure.

Various programs and data required for the operation of the electronic device 800 are stored in the RAM 803. The processor 801, the ROM 802 and the RAM 803 are connected to each other through a bus 804. The processor 801 executes various operations of the method flow according to embodiments of the present disclosure by executing the programs in the ROM 802 and/or the RAM 803. It should be noted that the program may also be stored in one or more memories other than the ROM 802 and the RAM 803. The processor 801 may also execute various operations of the method flow according to embodiments of the present disclosure by executing the programs stored in the one or more memories.

According to embodiments of the present disclosure, the electronic device 800 may further include an input/output (I/O) interface 805 which is also connected to the bus 804. The electronic device 800 may further include one or more of the following components connected to the I/O interface 805: an input portion 806 including a keyboard, a mouse, etc.; an output portion 807 including a cathode ray tube (CRT), a liquid crystal display (LCD), etc. and a speaker, etc.; a storage portion 808 including a hard disk, etc.; and a communication portion 809 including a network interface card such as a LAN card, a modem, and the like. The communication portion 809 performs communication processing via a network such as the Internet. A drive 810 is also connected to the I/O interface 805 as required. A removable medium 811, such as a magnetic disk, an optical disk, a magneto-optical disk, a semiconductor memory, and the like, is installed on the drive 810 as required, so that the computer program read therefrom is installed into the storage portion 808 as needed.

The present disclosure further provides a computer-readable storage medium, which may be included in the apparatus/device/system described in the above embodiments; or exist alone without being assembled into the apparatus/device/system. The above-mentioned computer-readable storage medium carries one or more programs that when executed, perform the methods according to embodiments of the present disclosure.

According to embodiments of the present disclosure, the computer-readable storage medium may be a non-transitory computer-readable storage medium, for example, may include but not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, the computer-readable storage medium may be any tangible medium that contains or stores programs that may be used by or in combination with an instruction execution system, apparatus or device. For example, according to embodiments of the present disclosure, the computer-readable storage medium may include the above-mentioned ROM 802 and/or RAM 803 and/or one or more memories other than the ROM 802 and RAM 803.

The embodiments of the present disclosure further include a computer program product, which contains a computer program. The computer program contains program code for performing the method provided by the embodiments of the present disclosure. When the computer program product runs on an electronic device, the program code causes the electronic device to implement the method of processing the image provided in the embodiments of the present disclosure.

When the computer program is executed by the processor 801, the above-mentioned functions defined in the system/apparatus of the embodiments of the present disclosure are performed. According to the embodiments of the present disclosure, the above-described systems, apparatuses, modules, units, etc. may be implemented by computer program modules.

In an embodiment, the computer program may rely on a tangible storage medium such as an optical storage device and a magnetic storage device. In another embodiment, the computer program may also be transmitted and distributed in the form of signals on a network medium, downloaded and installed through the communication portion 809, and/or installed from the removable medium 811. The program code contained in the computer program may be transmitted by any suitable medium, including but not limited to a wireless one, a wired one, or any suitable combination of the above.

In such embodiments, the computer program may be downloaded and installed from the network through the communication portion 809, and/or installed from the removable medium 811. When the computer program is executed by the processor 801, the above-mentioned functions defined in the system of the embodiments of the present disclosure are performed. According to the embodiments of the present disclosure, the above-described systems, apparatuses, devices, modules, units, etc. may be implemented by computer program modules.

According to the embodiments of the present disclosure, the program code for executing the computer programs provided by the embodiments of the present disclosure may be written in any combination of one or more programming languages. In particular, these computing programs may be implemented using high-level procedures and/or object-oriented programming languages, and/or assembly/machine languages. Programming languages include, but are not limited to, Java, C++, Python, “C” language or similar programming languages. The program code may be completely executed on the user computing device, partially executed on the user device, partially executed on the remote computing device, or completely executed on the remote computing device or server. In a case of involving a remote computing device, the remote computing device may be connected to a user computing device through any kind of network, including a local area network (LAN) or a wide area networks (WAN), or may be connected to an external computing device (e.g., through the Internet using an Internet service provider).

The flowcharts and block diagrams in the accompanying drawings illustrate the possible architecture, functions, and operations of the system, method, and computer program product according to various embodiments of the present disclosure. In this regard, each block in the flowcharts or block diagrams may represent a part of a module, a program segment, or a code, which part includes one or more executable instructions for implementing the specified logical function. It should be further noted that, in some alternative implementations, the functions noted in the blocks may also occur in a different order from that noted in the accompanying drawings. For example, two blocks shown in succession may actually be executed substantially in parallel, or they may sometimes be executed in a reverse order, depending on the functions involved. It should be further noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions.

Those skilled in the art may understand that the various embodiments of the present disclosure and/or the features described in the claims may be combined in various ways, even if such combinations are not explicitly described in the present disclosure. In particular, without departing from the spirit and teachings of the present disclosure, the various embodiments of the present disclosure and/or the features described in the claims may be combined in various ways. All these combinations fall within the scope of the present disclosure.

The embodiments of the present disclosure have been described above. However, these embodiments are for illustrative purposes only, and are not intended to limit the scope of the present disclosure. Although the various embodiments have been described separately above, this does not mean that measures in the respective embodiments may not be used in combination advantageously. The scope of the present disclosure is defined by the appended claims and their equivalents. Those skilled in the art may make various substitutions and modifications without departing from the scope of the present disclosure, and these substitutions and modifications should all fall within the scope of the present disclosure.

1. A method of processing an image, comprising:
constructing an initial three-dimensional face template by using a plurality of sample face images;
performing an iterative optimization on the initial three-dimensional face template by using a face image of a target object, so as to obtain a target three-dimensional face template; and
determining a current face pose of the target object according to a corresponding relationship between a current face image of the target object and the target three-dimensional face template.

2. The method of processing the image according to claim 1, wherein the constructing an initial three-dimensional face template by using a plurality of sample face images comprises:
acquiring a plurality of three-dimensional sample key points from each of the plurality of sample face images;
determining an average three-dimensional face template according to a plurality of three-dimensional sample key points of the plurality of sample face images;
determining a feature matrix of the plurality of sample face images by using the average three-dimensional face template; and
constructing the initial three-dimensional face template according to an iteration parameter, the average three-dimensional face template and the feature matrix.

3. The method of processing the image according to claim 2, wherein the determining a feature matrix of the plurality of sample face images by using the average three-dimensional face template comprises:
performing a decentralization on the plurality of three-dimensional sample key points of the plurality of sample face images by using the average three-dimensional face template, so as to obtain a covariance matrix;
calculating a plurality of feature values of the covariance matrix and a plurality of feature vectors corresponding to the plurality of feature values;
determining a plurality of valid feature vectors from the plurality of feature vectors according to contribution values of the plurality of feature values to a linear projection in the covariance matrix, wherein a sum of the contribution values of a plurality of feature values corresponding to the plurality of valid feature vectors is greater than a predetermined contribution value; and
constructing the feature matrix according to the plurality of valid feature vectors.

4. The method of processing the image according to claim 1, wherein the performing an iterative optimization on the initial three-dimensional face template by using a face image of a target object so as to obtain a target three-dimensional face template comprises:
acquiring a plurality of two-dimensional target key points from the face image of the target object;
determining a plurality of three-dimensional key points from the initial three-dimensional face template;
projecting the plurality of three-dimensional key points into a plurality of two-dimensional projection key points;
calculating an average error between the plurality of two-dimensional projection key points and the plurality of two-dimensional target key points; and
performing the iterative optimization on the initial three-dimensional face template according to the average error, so as to obtain the target three-dimensional face template.

5. The method of processing the image according to claim 4, wherein the projecting the plurality of three-dimensional key points into a plurality of two-dimensional projection key points comprises:
constructing a weak perspective projection model according to coordinate values of the three-dimensional key points, a scaling ratio, a coordinate system rotation matrix, and a center point offset vector of a pixel coordinate system; and
projecting the plurality of three-dimensional key points into a plurality of two-dimensional projection key points by using the weak perspective projection model.

6. The method of processing the image according to claim 5, wherein the weak perspective projection model is configured to project the plurality of three-dimensional key points into a plurality of two-dimensional projection key points according to:
$$[ \begin{matrix}x \\ y\end{matrix} ] = scale \cdot [ \begin{matrix}{R}_{00} & {R}_{01} & {R}_{02} \\ {R}_{10} & {R}_{11} & {R}_{21}\end{matrix} ] \cdot [ \begin{matrix}X \\ Y \\ Z\end{matrix} ] + [ \begin{matrix}{t}_{x} \\ {t}_{y}\end{matrix} ]$$
where x and y respectively represent coordinate values of the two-dimensional projection key points on x-axis and y-axis of the pixel coordinate system, X, Y and Z respectively represent coordinate values of the three-dimensional key points on x-axis, y-axis and z-axis of a coordinate system where the target object is located, scale represents the scaling ratio,
$$[ \begin{matrix}{R}_{00} & {R}_{01} & {R}_{02} \\ {R}_{10} & {R}_{11} & {R}_{21}\end{matrix} ]$$
represents a rotation matrix of the coordinate system where the target object is located with respect to a camera coordinate system, and tₓ and t_{y} respectively represent offset vectors of an origin of the pixel coordinate system with respect to an origin of the camera coordinate system on x-axis and y-axis.

7. The method of processing the image according to claim 5, wherein the performing the iterative optimization on the initial three-dimensional face template according to the average error so as to obtain the target three-dimensional face template comprises:
constructing an iteration model according to the weak perspective projection model and the iteration parameter;
determining a mapping function between the iteration model and the plurality of two-dimensional projection key points;
calculating a Jacobi matrix of the mapping function to obtain iteratively-optimized two-dimensional iterative key points;
calculating an average error according to the two-dimensional iterative key points and the plurality of two-dimensional target key points from the face image;
updating a parameter of the iteration model in a descent gradient direction of the Jacobi matrix to obtain an updated iteration model, and returning to an operation of determining the mapping function between the iteration model and the plurality of two-dimensional projection key points, in response to a determination that the average error does not meet a convergence condition; and
determining the iteration parameter and constructing the target three-dimensional face template according to the iteration parameter, in response to a determination that the average error meets the convergence condition.

8. The method of processing the image according to claim 7, wherein the mapping function comprises:
$$F ( [ \begin{matrix}scale \\ {R}_{x} \\ {R}_{y} \\ {R}_{z} \\ {t}_{x} \\ {t}_{y} \\ params\end{matrix} ] ) = [ \begin{matrix}current\_shape \_ 2 D\_x \\ current\_shape \_ 2 D\_y\end{matrix} ]$$
$$where [ \begin{matrix}current\_shape \_ 2 D\_x \\ current\_shape \_ 2 D\_y\end{matrix} ]$$
represents a coordinate value matrix of the plurality of two-dimensional projection key points,
$$F ( [ \begin{matrix}scale \\ {R}_{x} \\ {R}_{y} \\ {R}_{z} \\ {t}_{x} \\ {t}_{y} \\ params\end{matrix} ] )$$
represents the iteration model, scale represents the scaling ratio, Rₓ, R_{y} and R_{z} represent rotation amounts of the coordinate system where the target object is located with respect to the camera coordinate system, tₓ and t_{y} respectively represent offset vectors of an origin of the pixel coordinate system with respect to an origin of the camera coordinate system on x-axis and y-axis, and params represents the iteration parameter.

9. The method of processing the image according to claim 7, wherein the updating a parameter of the iteration model in a descent gradient direction of the Jacobi matrix to obtain an updated iteration model comprises:
calculating a parameter variation of the iteration model according to the descent gradient direction of the Jacobi matrix and the average error; and
updating the parameter of the iteration model according to the parameter variation, so as to obtain the updated iteration model.

10. The method of processing the image according to claim 9, wherein the updating the parameter of the iteration model according to the parameter variation so as to obtain the updated iteration model comprises updating the iteration model according to:
$$[ \begin{matrix}{scale}^{′} \\ {{R}_{x}}^{′} \\ {{R}_{y}}^{′} \\ {{R}_{z}}^{′} \\ {{t}_{x}}^{′} \\ {{t}_{y}}^{′} \\ {params}^{′}\end{matrix} ] = [ \begin{matrix}scale \\ {R}_{x} \\ {R}_{y} \\ {R}_{z} \\ {t}_{x} \\ {t}_{y} \\ params\end{matrix} ] - delta$$
$$where [ \begin{matrix}{scale}^{′} \\ {{R}_{x}}^{′} \\ {{R}_{y}}^{′} \\ {{R}_{z}}^{′} \\ {{t}_{x}}^{′} \\ {{t}_{y}}^{′} \\ {params}^{′}\end{matrix} ]$$
represents the updated iteration model,
$$[ \begin{matrix}scale \\ {R}_{x} \\ {R}_{y} \\ {R}_{z} \\ {t}_{x} \\ {t}_{y} \\ params\end{matrix} ]$$
represents anun-updated iteration model, and delta represents the parameter variation.

11. The method of processing the image according to claim 4, wherein the calculating an average error between the plurality of two-dimensional projection key points and the plurality of two-dimensional target key points comprises:
calculating a re-projection error according to the plurality of two-dimensional projection key points and the plurality of two-dimensional target key points; and
calculating the average error according to the re-projection error.

12. The method of processing the image according to claim 11, wherein the calculating the average error according to the re-projection error comprises calculating the average error according to:
$$error = \frac{1}{68} {\sum }_{i = 0}^{67} {‖ {proj}_{err} ‖}^{2}$$
where error represents the average error, projₑᵣᵣ represents the re-projection error,
$${proj}_{err} = landmarks\_ 2 D - current\_shape \_ 2 D , landmarks\_ 2 D$$
represents the coordinate values of the two-dimensional target key points, and current_shape_2D represents the coordinate values of the two-dimensional projection key points.

13. The method of processing the image according to claim 1, wherein the determining a current face pose of the target object according to a corresponding relationship between a current face image of the target object and the target three-dimensional face template comprises:
determining a plurality of predetermined three-dimensional key points of the target object from a plurality of three-dimensional key points of the target three-dimensional face template, wherein the plurality of predetermined three-dimensional key points are located in a target coordinate system, and the plurality of predetermined three-dimensional key points correspond to a plurality of specified two-dimensional key points of the current face image of the target object;
determining a transformation matrix between the camera coordinate system and the target coordinate system according to a corresponding relationship between the pixel coordinate system where the face image from a camera is located and the target coordinate system;
converting the plurality of predetermined three-dimensional key points into a plurality of target three-dimensional key points according to the transformation matrix, wherein the plurality of target three-dimensional key points are located in the camera coordinate system; and
determining the current face pose of the target object according to the plurality of target three-dimensional key points.

14. The method of processing the image according to claim 13, wherein the determining a transformation matrix between the camera coordinate system and the target coordinate system according to a corresponding relationship between the pixel coordinate system where the face image from a camera is located and the target coordinate system comprises determining the transformation matrix according to:
$$c [ \begin{matrix}x \\ y \\ 1\end{matrix} ] = K \cdot [ \begin{matrix}R & t \\ 0 & 1\end{matrix} ] \cdot [ \begin{matrix}X \\ Y \\ Z \\ 1\end{matrix} ]$$
where c represents a scale of the camera, x and y respectively represent coordinate values of the two-dimensional projection key points on x-axis and y-axis of the pixel coordinate system, X, Y and Z respectively represent coordinate values of the predetermined three-dimensional key points on x-axis, y-axis and z-axis of the target coordinate system, K represents an internal parameter matrix of the camera, and
$$[ \begin{matrix}R & t \\ 0 & 1\end{matrix} ]$$
represents the transformation matrix.

15. The method of processing the image according to claim 4, wherein the acquiring a plurality of two-dimensional target key points from the face image of the target object comprises:
performing a distortion correction on the face image to obtain a corrected face image; and
determining the plurality of two-dimensional target key points from the corrected face image by using a key point detection algorithm.

16. The method of processing the image according to claim 15, wherein the performing a distortion correction on the face image to obtain a corrected face image comprises:
performing the distortion correction on the face image according to:
$$\{ \begin{matrix}{x}_{0} = x ( 1 + {k}_{1} {r}^{2} + {k}_{2} {r}^{4} + {k}_{3} {r}^{6} ) \\ {y}_{0} = y ( 1 + {k}_{1} {r}^{2} + {k}_{2} {r}^{4} + {k}_{3} {r}^{6} ) \\ {x}_{0} = x + [ 2 {p}_{1} xy + {p}_{2} ( {r}^{2} + 2 {x}^{2} ) ] \\ {x}_{0} = x + [ 2 {p}_{1} xy + {p}_{2} ( {r}^{2} + 2 {x}^{2} ) ]\end{matrix}$$
where x₀ and y₀ respectively represent coordinate values of a coordinate point on the face image on x-axis and y-axis, x and y respectively represent coordinate values of a coordinate point on the corrected face image on x-axis and y-axis, r represents a distance between a center point of the face image and the coordinate point (x, y), k₁, k₂ and k₃ are radial distortion coefficients, and p₁ and p₂ are tangential distortion coefficients.

17. An apparatus of processing an image, comprising:
a construction module configured to construct an initial three-dimensional face template by using a plurality of sample face images;
an iteration module configured to perform an iterative optimization on the initial three-dimensional face template by using a face image of a target object, so as to obtain a target three-dimensional face template; and
a determination module configured to determine a current face pose of the target object according to a corresponding relationship between a current face image of the target object and the target three-dimensional face template.

18. An interactive device, comprising:
a camera configured to acquire a face image of a target object;
a processor electrically connected to the camera, wherein the processor is configured to:
perform an iterative optimization on an initial three-dimensional face template by using the face image so as to obtain a target three-dimensional face template;
perform a face pose estimation by using the target three-dimensional face template so as to obtain pupil coordinates of the target object; and
calculate a grating opening and closing sequence according to the pupil coordinates;
a driving circuit electrically connected to the processor, wherein the driving circuit is configured to control an output interface to output the grating opening and closing sequence; and
a screen electrically connected to the driving circuit, wherein the screen is configured to control opening and closing of a grating in the screen according to the grating opening and closing sequence.

19. An electronic device, comprising:
one or more processors; and
a memory configured to store one or more programs, wherein the one or more programs, when executed by the one or more processors, are configured to cause the one or more processors to implement the method of claim 1.

20. A computer-readable storage medium having executable instructions therein, wherein the instructions, when executed by a processor, are configured to cause the processor to implement the method of claim 1.

21. (canceled)
